(19) United States
(12) Patent Application Publication
(10) Pub. No.: US 2015/0294360 A1
(43) Pub. Date: Oct. 15, 2015

(54) Clustering of Ads with Organic Map Content

(71) Applicant: Google Inc., Mountain View, CA (US)

(72) Inventors: Jordan John Bayliss-Mcculloch, Sydney (AU); Alexander Max Berry, Pyrmont (AU)

(21) Appl. No.: 14/751,374

(22) Filed: Jun. 26, 2015

Related U.S. Application Data
(63) Continuation of application No. 13/830,219, filed on Mar. 14, 2013.

(51) Int. Cl. G06Q 30/02; G06F 17/30

(52) U.S. Cl. CPC G06Q 30/0259; G06Q 30/0256; G06F 17/30241

(57) ABSTRACT

A system and method for facilitating clustering of ads and map content, the method including receiving a request associated with a target region on a map from a user device, identifying an ad for display to a user based at least in part on the received search request, determining a location associated with an ad of the one or more ads, determining a region criteria based on the location of the ad, retrieving, one or more map content items having a location meeting the determined region criteria, comparing the ad and the retrieved one or more map content items to identify a map content item associated with the same entity as the ad and providing the ad and the identified map content item to the user at the user device, wherein the map content item is displayed as a single entity with an identifier of the map content item.

### BACKGROUND

When rendering maps, it may be beneficial to include advertisements on the displayed map in order to monetize the map data being displayed to the user. When including advertisements (“ads”), one challenge may be to efficiently identify ads to be displayed with map data and to place the ads on the map in a way that is easy for the user to view and to associate with the appropriate objects on the map.

### SUMMARY

The disclosed subject matter relates to a computer-implemented method for facilitating clustering of ads and map content, the method comprising receiving, using one or more computing devices, a request from a user device, wherein the request is associated with a target region on a map. The method further comprising identifying, using the one or more computing devices, an ad for display to a user based at least in part on the received search request. The method further comprising determining, using the one or more computing devices, a location associated with an ad of the one or more ads. The method further comprising determining, using the one or more computing devices, a region criteria based on the location of the ad. The method further comprising retrieving, using the one or more computing devices, one or more map content items having a location meeting the determined region criteria. The method further comprising comparing, using the one or more computing devices, the ad and the retrieved one or more map content items to identify a map content item associated with the same entity as the ad and providing, using the one or more computing devices, the ad and the identified map content item to the user at the user device, wherein the map content item is displayed as a single entity with an identifier of the map content item.

The disclosed subject matter also relates to a system for facilitating clustering of ads and map content, the system comprising one or more processors and a machine-readable medium comprising instructions stored therein, which when executed by the processors, cause the processors to perform operations comprising identifying an ad for display to a user in response to a user request at a user device, wherein the user request is search request for a target region within a map. The operations further comprising determining a location associated with the ad. The operations further comprising determining a map region based on the determined location of the ad. The operations further comprising generating a query to retrieve one or more map content items, the query including one or more search criteria, the search criteria comprising the determined map region. The operations further comprising receiving one or more map content items having a location within the map region in response to the query, wherein the number of map content items of the one or more map content items is limited to a predefined result threshold. The operations further comprising determining whether a map content item of the one or more map content items is associated with a same entity associated with the ad and clustering the map content and the ad when it is determined that the map content is associated with the same entity associated with the ad.

The disclosed subject matter also relates to a machine-readable medium comprising instructions stored therein, which when executed by a machine, cause the machine to perform operations comprising receiving a search request from a user device relating to a target region within a map. The operations further comprising identifying an ad for display within the map in response to the search request, the ad being associated with entity data regarding the entity to which the ad pertains and a location. The operations further comprising determining a map region based on the location of the ad. The operations further comprising generating a first query to retrieve map content relating to the ad according to the map region. The operations further comprising receiving one or more map content items having a location within the map region in response to the first query, wherein at least one map content item of the one or more map content items is associated with entity data regarding the entity to which the at least one map content item pertains. The operations further comprising identifying whether the at least one map content item is associated with the same entity associated with the ad based on comparing one or more of the entity data associated with the ad with the corresponding one or more entity data associated with the at least one map content item and clustering the at least one map content item and the ad when it is determined that the map content item is associated with the same entity associated with the ad.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

Certain features of the subject technology are set forth in the appended claims. However, for purpose of explanation, several embodiments of the subject technology are set forth in the following figures.

FIG. 1 illustrates an example client-server network environment which provides for facilitating clustering of ads with map content.

FIG. 2 illustrates a process for clustering map content with ads relating to the same entity as the map content.

FIG. 3 illustrates an example graphical user interface displaying a map including a user query mechanism for receiving a user query from a user.

FIG. 4 illustrates an example graphical user interface displaying a map displaying an entity matching a search query with a clustered ad relating to the entity.

FIG. 5 conceptually illustrates an electronic system with which some implementations of the subject technology are implemented.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

I. Overview

The subject disclosure provides a method for efficiently clustering ads with map content. Ads can be clustered with organic map content, if it is determined that the organic map content and the ad both refer to the same entity (e.g., a name of a restaurant on a map and an advertisement for the restaurant). That is, when it is determined that an ad an map content (e.g., a label) refer to the same entity such as a restaurant, instead of displaying the name of the restaurant and a separate ad, the advertisement and name of the restaurant are clustered and provided within a single entry on the map. In one example, to perform clustering, a set of ads relating to a set of organic map content (e.g., points of interest retrieved in response to a search request or other user query) are retrieved. The set of ads are compared to the set of organic map content (e.g., using fuzzy matching based on name, address, phone number, or other identifier associated with the map content and/or the ad). In response to the comparison, ads and map content corresponding to the same entity are identified and clustered.

Retrieving all organic results within a viewport can be difficult or infeasible due to the large volume of data. For example, when looking at the entire USA, the number of organic results has to be artificially limited, due to possible overload of the backend server serving the organic map data, frontend memory limits, clutter on the displayed image, and/or the time taken to compare a large number of results.

To address these limitations and introduce efficiency into the clustering process, an approach is provided to reduce the amount of map content (number of organic results) required by the server to cluster ads with organic map content. In addition to promoting efficiency, by reducing the number of map content and therefore the number of comparisons necessary, accuracy is also improved as the reduction in number of results removes any concerns with backend or front end serving, analysis or memory limitations and minimizes the necessity for artificial limitations on the number of organic map content.

The processes described herein limit the number of results (e.g., organic map content) necessary to perform clustering, and facilitate prioritizing the retrieved results such that the retrieved results lead to the greatest likelihood of successfully clustering ads. The retrieval of organic map content and ads and clustering of map content with ads is divided into two different processes. First, one or more map content and/or ads are retrieved. In one example, the retrieved map content and/or ads correspond to results of a search query or other request by a user.

Each map content and/or ad is associated with a set of information including location (e.g., defined in terms of latitude/longitude in a 2D map), entity identifier (e.g., title or name of business or entity associated with the ad or organic map content), entity domain name, entity phone number, or other similar information identifying the entity associated with the map content or ad. As clustering requires that an ad and organic map content be associated with the same entity, the distance between an ad and organic map content having a probability of being clustered can be limited to a distance limit (e.g., 250 meters).

The location of the ad is used to generate a query for map content within a threshold region defined in terms of the location of the ad (e.g., organic map content a “D” distance away from the location of the ad, where D is a threshold distance). The coordinate space could be defined in terms of different location identifiers, and the region may be represented in different ways. For example, S2 indexes and/or latitude/longitude may be used to define the location of the ad. Additionally, the region around each ad could be rectangular, circular or of another shape, and the region could be represented in different ways. The request can be for organic map content meeting the original search query or all map content available that are within the defined region. In some implementations, instead of a defined radius or region, it would be possible to ask a search server for N results, near M points, such that each point has roughly N/M nearby results, sorted by distance. This reduces the need to have a hard-coded clustering distance.

The request may return a defined number (“N”) results. In one example, a single request is sent for all ads where the number of results (e.g., organic map content within a D distance of the ad location) may be limited to N/(number of ads) for each ad. To maximize the likelihood of clustering, the number results per region could be distributed such that at most N/(number of ads) search results are returned around each point. In some implementations, a separate query may be issued for each ad and/or each region (the region defined around the ad location). In one or more implementations, the returned search results, around each point, are ranked by the distance from each respective point (instead of ranking based primarily on relevance). This ensures that if search results need to be dropped (more than N could be returned), the results less likely to cluster with the ad are dropped first.

The results for each ad, which includes one or more organic map content (e.g., up to “N” search results) within a defined region around the location of the ad, are then compared to the ad and clustering is performed (e.g., using some fuzzy matching). In one example, the fuzzy matching is performed by using entity information associated with the ad and the one or more organic map results. For example, the fuzzy matching may be performed according to comparing one or more of the entity name, entity phone number or entity domain name associated with the ad and each of the one or more organic map content (e.g., map content returned being a distance D from the location of the ad). In one example, the matching may first filter organic map content according to entity name and next confirm clustering using the entity phone number and/or domain name. In other implementations, different combinations of selection and confirmation entity characteristics may similarly be used to identify organic map content corresponding to the same entity as an ad.

The comparison and/or clustering may be performed by the server and the clustered entity may be returned for the ad. In other implementations, the organic map content meeting the query may be provided to the client, and the client may perform the clustering process to identify the organic map content to cluster with the ad. In this manner, instead of being limited to a certain number of results per viewport, the query is restricted to a certain number of results in close proximity to the ads. In some implementations, the results are ranked by their proximity to their respective ad. In some implementations, the comparison may be performed according to the ranking (e.g., the results with the most likelihood of being clustered with the ad are compared first). The comparison according to ranking allows the system to take advantage of the assumption that ads and map content corresponding to the same entity are likely to be proximate to one another. The ranking further ensures that if the returned results need to be limited, (e.g., because of the threshold number of results), the most likely map content to be clustered with the ad are returned for comparison.

The described method may also be used for search, if it is desirable to rank results based on proximity to a location(s) (known before the search is performed). For example, searching for “pizza near a station” could determine the locations for stations in the viewport, and the results may be filtered according to their distance to the station.

II. Example Processes for Clustering Advertisements with Organic Map Content

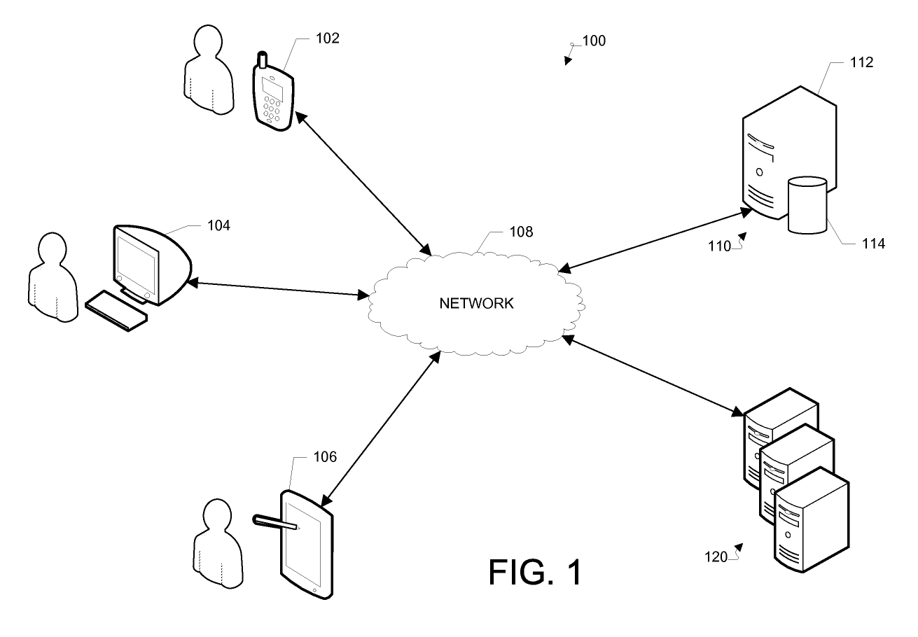

FIG. 1 illustrates an example client-server network environment which provides for facilitating clustering of ads with map content. A network environment 100 includes a number of electronic devices 102, 104 and 106 communicably connected to a server 110 by a network 108. One or more remote servers 120 are further coupled to the server 110 and/or the one or more electronic devices 102, 104 and 106. Server 110 includes a processing device 112 and a data store 114. Processing device 112 executes computer instructions stored in data store 114, for example, to assist in clustering ads with organic map content at electronic devices 102, 104 and 106.

In some example embodiments, electronic devices 102, 104 and 106 can be computing devices such as laptop or desktop computers, smartphones, PDAs, portable media players, tablet computers, televisions or other displays with one or more processors coupled thereto or embedded therein, or other appropriate computing devices that can be used to for displaying a web page or web application. In one example, the electronic devices 102, 104 and 106 store a User agent such as a browser or application, for displaying a map including organic map content (e.g., actual map data) and ad (e.g., advertisements placed on the map). In one example, the application may further perform one or more processes or blocks in the process for clustering ads and organic map content (e.g., as the client). In one example, the client application may be hosted at a server (e.g., server 110). In the example of FIG. 1, electronic device 102 is depicted as a smartphone, electronic device 104 is depicted as a desktop computer, and electronic device 106 is depicted as a PDA.

In some example aspects, server 110 can be a single computing device such as a computer server. In other embodiments, server 110 can represent more than one computing device working together to perform the actions of a server computer (e.g., cloud computing). The server 110 may host the web server communicationally coupled to the browser at the client device (e.g., electronic devices 102, 104 or 106) via network 108. In one example, the server 110 may host the system or processes for requesting map content, for receiving map content and ads and/or for clustering map content and/or ads for display at the user client device.

Each of the one or more remote servers 120 can be a single computing device such as a computer server or can represent more than one computing device working together to perform the actions of a server computer (e.g., cloud computing). Each of the one or more remote servers 120 may host one or more content providers for providing map content, ads or other content for display on the map.

In one embodiment server 110 and one or more remote servers 120 may be implemented as a single server hosting the central account manager and/or one or more service providers (e.g., websites and/or applications). In one example, the server 110 and one or more remote servers 120 may communicate through the user agent at the client device (e.g., electronic devices 102, 104 or 106) via network 108.

The network 108 can include, for example, any one or more of a personal area network (PAN), a local area network (LAN), a campus area network (CAN), a metropolitan area network (MAN), a wide area network (WAN), a broadband network (BBN), the Internet, and the like. Further, the network 108 can include, but is not limited to, any one or more of the following network topologies, including a bus network, a star network, a ring network, a mesh network, a star-bus network, tree or hierarchical network, and the like.

III. Example Processes for Clustering Advertisements with Organic Map Content

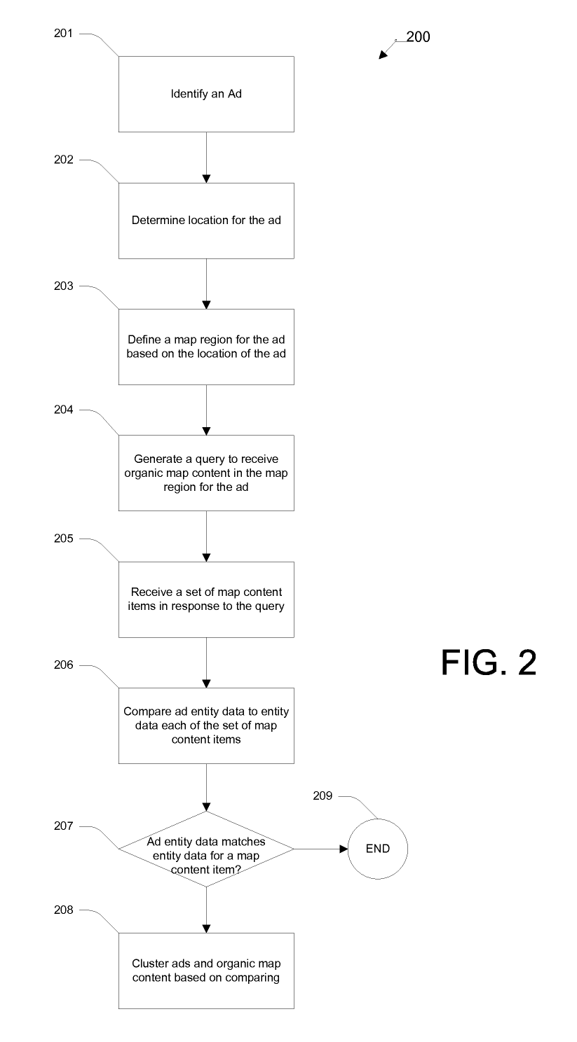

FIG. 2 illustrates a process 200 for clustering map content with ads relating to the same entity as the map content. In some implementations, the clustering of ad content with organic map content is performed so that map content referring to an entity can be grouped with ads relating to the same entity and displayed to the user as a single entity on a map being displayed to the user.

In block 201, an ad is identified. In one example, when a user requests map content (e.g., searches for an address or entity on the map), a set of map content and ads matching the search query are returned for display within a map in response to the user request. In one example, the process 200 described herein may be performed for the one or more of the ads returned in response to the user request.

In block 202, the location of the ad is determined. In some examples, the ad is associated with entity data relating to the entity corresponding to the ad (e.g., the advertiser, or sponsor of the ad, the business advertised in the ad, a business offering the advertised product or service, etc.). The entity information may include one or more of entity location (e.g., address, map latitude/longitude), identifier, name, phone number, domain name, entity type, entity category, entity related products and/or services, entity related people and other similar information relating to the entity. In one example, an entity may refer to a person or business. In one example, the ad location is determined based on the entity data associated with the business.

In block 203, a map region for the ad is defined based on the location of the ad. The map region may be defined in relation to the location of the ad determined in block 202. The map region may, for example, be defined as an area around the location of the map (e.g., within a radius or distance D away from the location of the ad). In some implementations, the map region may be defined in terms of different location identifiers, and the region may be represented in different ways. For example, S2 indexes and/or latitude/longitude may be used to define the location of the ad. Additionally, the region around each ad could be rectangular, circular or of another shape, and the region could be represented in different ways.

In block 204, a query is generated to retrieve organic map content relating to the ad. The query, in some implementations, includes the map region defined in block 203. The query may further include search criteria (e.g., the search criteria included in the original search query by the user and/or entity data relating to the ad).

In block 205, in response to the query one or more organic map content items are received. In one example, the one or more map content items are located within the map region defined in block 203. In some implementations, the organic map content items are selected based on one or more search criteria included in the search query generated in block 204. The request may return a defined number (“N”) results.). In one or more implementations, the returned search results, around each point, are ranked by the distance from each respective point (instead of ranking based primarily on relevance). This ensures that if search results need to be dropped (more than N could be returned), the results less likely to cluster with the ad are dropped first.

The organic map content item may be associated with entity data relating to the entity represented by or associated with the map content items, including one or more of entity location (e.g., address, map latitude/longitude), identifier, name, phone number, domain name, entity type, entity category, entity related products and/or services, entity related people and other similar information relating to the entity. In some implementations, the organic map data retrieved in block 205 may include only organic map content items that were retrieved in the original search (e.g., the user query that returned the ad content), or may include any organic map content items.

In block 206, the one or more map content items is compared with the ad to determine if the ad can be clustered with any organic map content item. In one example one or more of the entity data associated with the ad is compared to the data relating to the map content items. For example, the name or identifier of the entity associated with the ad may be compared to the name or identifier of the entity associated with the organic map content item. Similarly other entity information associated with the ad may be compared against the entity information associated with the map content item. In one implementation, a first set of entity information corresponding to the ad (e.g., entity name) is compared to the corresponding set of entity information corresponding to the content. When it is determined that the first set of entity information of the ad matches the corresponding set of entity information for the map content item, the comparison may be further confirmed by comparing other entity information such as the entity phone number and/or domain name of the ad and map content item.

In block 207, it is determined if the entity data of the ad matches the entity data of any of the one or more map content items. If so, then it may be inferred that the ad and the map content item refer to the same entity and thus may be clustered. Thus, in block 208, the map content item and ad content are clustered. The clustered ad and map content item may then be provided for display to the user as a separate entity in the map being displayed to the user. If, one the other hand, it is determined that there are no map content item that match the ad the process ends in block 209.

While process 200 is described with respect to a single ad, as described above, the same process may be repeated for multiple ads. In some implementations a separate query may be issued for each ad. In other examples, a single query may be issued to retrieve map content associated with a plurality of ads. The map content is then received for each ad and the ads may be clustered with map content according to the above processes.

IV. Example Graphical User Interfaces Illustrating Clustering of Ads and Map Content

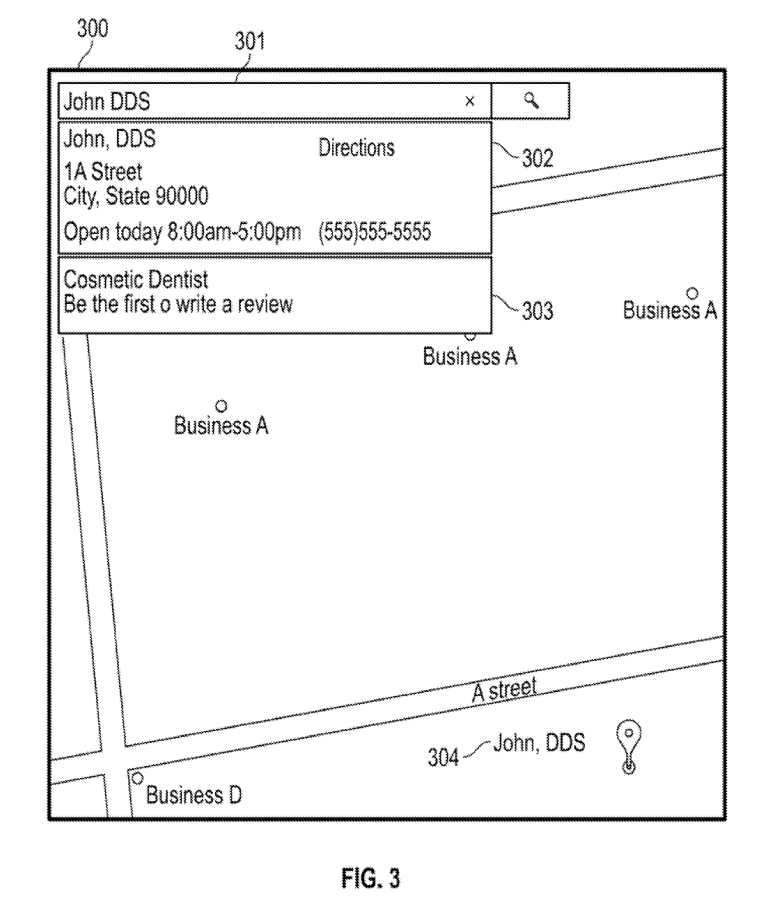

FIG. 3 illustrates an example graphical user interface displaying a map 300 including a user query mechanism for receiving a user query from a user. The graphical user interface includes a map 300 and a search mechanism 301 for entering queries for one or more entities and/or map content. A user viewing the map 300, generated from a collection of map content, may enter a query (e.g., one or more search terms or phrases) into the search mechanism 301. The search results retrieved in response to the query may be displayed to the user within a results display area 302. The search result, in one example, may include an entity identifier of an entity matching the search criteria entered into the search mechanism 301 along with entity data relating to the entity. An auxiliary information area 303 may further be provided for providing other entity information and/or for allowing the user to enter information (e.g., rating or reviews) for the entity. In response to the query, map content relating to the query may be retrieved (e.g., map content for generating a map for display including the point of interest matching the query and the surrounding areas). The map may be displayed, including the entity 304 matching the query. As described above, in addition to the map content, one or more ads may also be retrieved in response to the query.

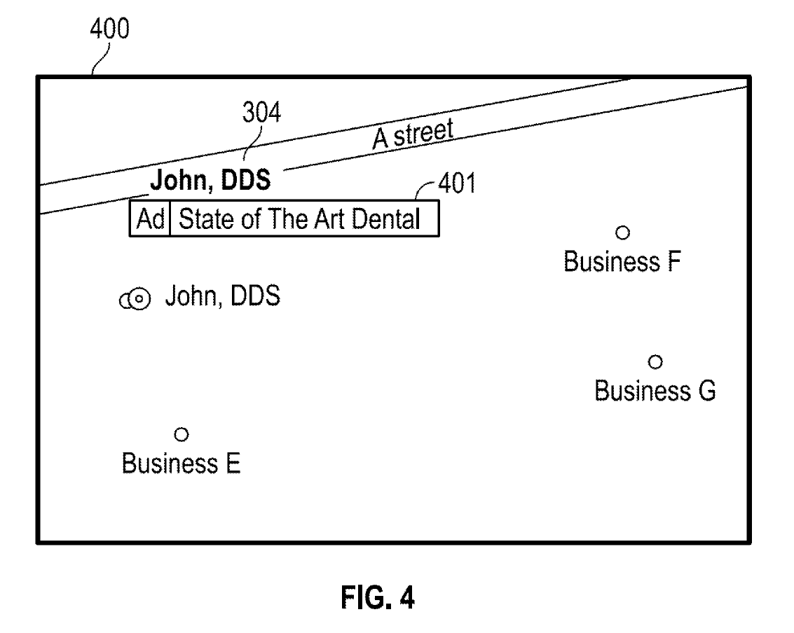

FIG. 4 illustrates an example graphical user interface displaying a map 400 displaying an entity matching a search query with a clustered ad relating to the entity. As shown a map is generated including one or more entities including the entity 304 matching the search query. The entity 304 is clustered with an ad 401. In one or more implementations, the ad 401 is clustered with entity 304 according to the processes described herein.

IV. Example System for Facilitating Clustering of Ads and Map Content

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

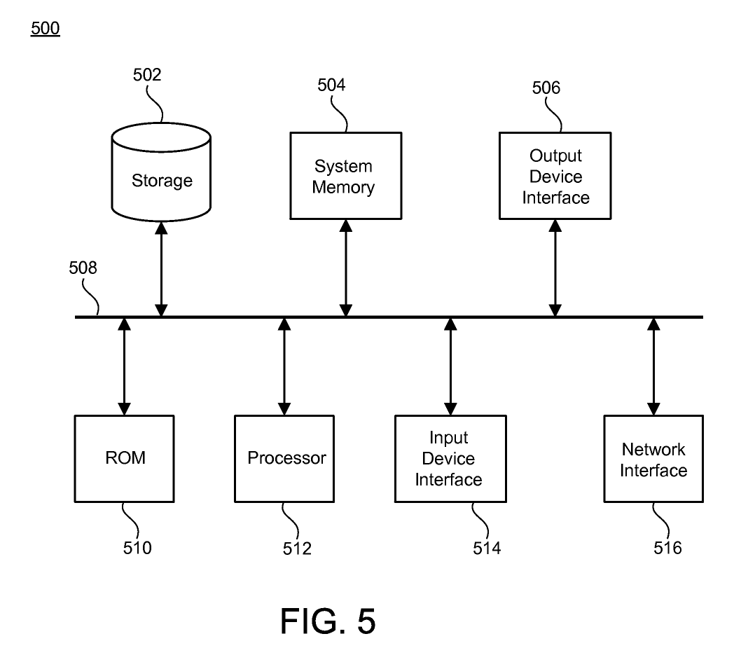

FIG. 5 conceptually illustrates an electronic system with which some implementations of the subject technology are implemented. Electronic system 500 can be a server, computer, phone, PDA, laptop, tablet computer, television with one or more processors embedded therein or coupled thereto, or any other sort of electronic device. Such an electronic system includes various types of computer readable media and interfaces for various other types of computer readable media. Electronic system 500 includes a bus 508, processing unit(s) 512, a system memory 504, a read-only memory (ROM) 510, a permanent storage device 502, an input device interface 514, an output device interface 506, and a network interface 516.

Bus 508 collectively represents all system, peripheral, and chipset buses that communicatively connect the numerous internal devices of electronic system 500. For instance, bus 508 communicatively connects processing unit(s) 512 with ROM 510, system memory 504, and permanent storage device 502.

From these various memory units, processing unit(s) 512 retrieves instructions to execute and data to process in order to execute the processes of the subject disclosure. The processing unit(s) can be a single processor or a multi-core processor in different implementations.

ROM 510 stores static data and instructions that are needed by processing unit(s) 512 and other modules of the electronic system. Permanent storage device 502, on the other hand, is a read-and-write memory device. This device is a non-volatile memory unit that stores instructions and data even when electronic system 500 is off. Some implementations of the subject disclosure use a mass-storage device (such as a magnetic or optical disk and its corresponding disk drive) as permanent storage device 502.

Other implementations use a removable storage device (such as a floppy disk, flash drive, and its corresponding disk drive) as permanent storage device 502. Like permanent storage device 502, system memory 504 is a read-and-write memory device. However, unlike storage device 502, system memory 504 is a volatile read-and-write memory, such a random access memory. System memory 504 stores some of the instructions and data that the processor needs at runtime. In some implementations, the processes of the subject disclosure are stored in system memory 504, permanent storage device 502, and/or ROM 510. For example, the various memory units include instructions for facilitating clustering of ad and map content according to various embodiments. From these various memory units, processing unit(s) 512 retrieves instructions to execute and data to process in order to execute the processes of some implementations.

Bus 508 also connects to input and output device interfaces 514 and 506. Input device interface 514 enables the user to communicate information and select commands to the electronic system. Input devices used with input device interface 514 include, for example, alphanumeric keyboards and pointing devices (also called “cursor control devices”). Output device interfaces 506 enables, for example, the display of images generated by the electronic system 500. Output devices used with output device interface 506 include, for example, printers and display devices, such as cathode ray tubes (CRT) or liquid crystal displays (LCD). Some implementations include devices such as a touchscreen that functions as both input and output devices.

Finally, as shown in FIG. 5, bus 508 also couples electronic system 500 to a network (not shown) through a network interface 516. In this manner, the computer can be a part of a network of computers (such as a local area network (“LAN”), a wide area network (“WAN”), or an Intranet, or a network of networks, such as the Internet. Any or all components of electronic system 500 can be used in conjunction with the subject disclosure.

These functions described above can be implemented in digital electronic circuitry, in computer software, firmware or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself

As used in this specification and any claims of this application, the terms “computer”, “server”, “processor”, and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

It is understood that any specific order or hierarchy of blocks in the processes disclosed is an illustration of exemplary approaches. Based upon design preferences, it is understood that the specific order or hierarchy of blocks in the processes may be rearranged, or that some illustrated blocks may not be performed. Some of the blocks may be performed simultaneously. For example, in certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure. Features under one heading may be combined with features under one or more other heading and all features under one heading need not be use together. Features under one heading may be combined with features under one or more other heading and all features under one heading need not be use together.

A phrase such as an “aspect” does not imply that such aspect is essential to the subject technology or that such aspect applies to all configurations of the subject technology. A disclosure relating to an aspect may apply to all configurations, or one or more configurations. A phrase such as an aspect may refer to one or more aspects and vice versa. A phrase such as a “configuration” does not imply that such configuration is essential to the subject technology or that such configuration applies to all configurations of the subject technology. A disclosure relating to a configuration may apply to all configurations, or one or more configurations. A phrase such as a configuration may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1-21. (canceled)

22. A computer-implemented method for facilitating clustering of ads and map content, the method comprising:
receiving, using one or more computing devices, a request from a user device, wherein the request is associated with a target region on a map;
identifying, using the one or more computing devices, a number (M) of one or more ads for display to a user based at least in part on the received search request;
determining, using the one or more computing devices, a map location associated with each ad of the one or more ads;
determining, using the one or more computing devices, a region criteria defined in terms of the map location of each ad of the one or more ads;
retrieving, using the one or more computing devices, one or more map content items for each of the one or more ads, wherein map content items for each ad have a map location meeting the determined region criteria for that ad, wherein the number of retrieved map content items is limited for each of the one or more ads by at least the region criteria;
comparing, using the one or more computing devices, each ad and the retrieved one or more map content items for each ad to identify a map content item associated with the same entity as each ad; and
clustering, using the one or more computing devices, each ad and the identified map content item for each ad such that each ad and identified map content item for that ad is displayed as a single entity within the map at the user device.

23. The method of claim 22, further comprising providing for display, by the one or more computing devices, in response to the request from the user device, the map including each ad and identified map content item for that ad displayed as a single entity within the map.

24. The method of claim 22, wherein the number of retrieved map content items is further limited to a total number (N) of results.

25. The method of claim 24, wherein the number of retrieved map content items is limited for each ad in the number (M) of one or more ads to N/M content items for each ad, such that each ad has about N/M nearby content items retrieved for subsequent comparison.

26. The method of claim 22, wherein the determined region criteria is defined such that the distance between the map location corresponding to each ad and the map location for map content items retrieved for that ad is limited to a predetermined distance limit.

27. The method of claim 26, wherein the predetermined distance limit is defined such that the distance between the map location for each ad and the map location for map content items retrieved for that ad is no greater than about 250 meters.

28. The method of claim 22, wherein the one or more map content items retrieved for each ad are ranked according to the distance from the map location of each retrieved map content item to the map location for the that ad.

29. The method of claim 28, wherein the comparing is performed according to the ranking, where the higher ranked map content items for that ad are compared first with the ad.

30. The method of claim 22, wherein the comparing comprises:
comparing an entity name associated with each ad with an entity name associated with one or more of the one or more map content items retrieved for that ad; and
determining one or more candidate map content items from the one or more map content items for each ad, the one or more candidate map content items including the identified map content item, wherein the entity name associated with each ad matches the entity name associated with each of the one or more candidate map content items for that ad.

31. The method of claim 30, wherein the comparing further comprises:
comparing one or more of an entity phone number and entity domain name associated with each of the one or more candidate map content items with the one or more of an entity phone number and entity domain name associated with the corresponding ad; and
determining that the identified map content item of the one or more candidate map content items for each ad is associated with the same entity as that ad if the one or more of an entity phone number and entity domain name of the identified map content item matches with the corresponding one or more of an entity phone number and entity domain name associated with the ad.

32. The method of claim 22, wherein each of the one or more ads and each of the one or more map content items is associated with one or more entity characteristics corresponding to the entity related to the ad or map content item, the one or more entity characteristics comprising one or more of an entity name, entity phone number or entity domain name.

33. A system for facilitating clustering of ads and map content, the system comprising:
one or more processors; and
a machine-readable medium comprising instructions stored therein, which when executed by the processors, cause the processors to perform operations comprising:
identifying a number (M) of one or more ads for display to a user in response to a user request at a user device, wherein the user request is a search request for a target region within a map;
determining a map location associated with each ad;
determining a map region based on the determined map location of each ad;
generating a query to retrieve one or more map content items for each ad, each query including one or more search criteria, the search criteria comprising the determined map region for each ad;
receiving one or more map content items having a location within the map region in response to each query, wherein the number of map content items of the one or more map content items is limited to a predefined result threshold;
determining whether a map content item of the one or more map content items is associated with a same entity associated with each ad;
clustering a map content item and its corresponding ad when it is determined that the map content is associated with the same entity associated with the corresponding ad; and
providing for display, in response to the user request at the user device, a map including each clustered map content item and its corresponding ad.

34. The system of claim 33, wherein the predefined result threshold is limited to a total number (N) of results such that the number of retrieved map content items is limited for each ad in the number (M) of one or more ads to N/M content items for each ad.

35. The system of claim 33, wherein the determined map region is defined such that the distance between the map location corresponding to each ad and the map location for map content items received for that ad is limited to a predetermined distance limit.

36. The system of claim 35, wherein the predetermined distance limit is defined such that the distance between the map location for each ad and the map location for map content items received for that ad is no greater than about 250 meters.

37. The system of claim 33, wherein the one or more map content items retrieved for each ad are ranked according to the distance from the map location of each received map content item to the map location for that ad.

38. A machine-readable medium comprising instructions stored therein, which when executed by a machine, cause the machine to perform operations comprising:
receiving a search request from a user device relating to a target region within a map;
identifying an ad for display within the map in response to the search request, the ad being associated with entity data regarding the entity to which the ad pertains and a map location;
determining a map region based on the map location of the ad;
generating a first query to retrieve map content relating to the ad according to the map region, wherein the first query sets a limit for the total number (N) of results;
receiving one or more map content items having a location within the map region in response to the first query, wherein at least one map content item of the one or more map content items is associated with entity data regarding the entity to which the at least one map content item pertains;
identifying whether the at least one map content item is associated with the same entity associated with the ad based on comparing one or more of the entity data associated with the ad with the corresponding one or more entity data associated with the at least one map content item;
clustering the at least one map content item and the ad when it is determined that the map content item is associated with the same entity associated with the ad; and
providing for display, in response to the search request from the user device, the at least one map content item and clustered ad.

39. The machine-readable medium of claim 38, the operations further comprising:
identifying a second ad for display within the map in response to the search request;
determining a second map region based on the location of the second ad, wherein the first query further retrieves map content relating to the second ad according to the second map region, wherein the number of retrieved map content items is limited for each of the first and second ads to N/2 content items for each ad:
receiving one or more other map content items having a location within the second map region;
identifying whether at least one map content item of the other one or more map content items is associated with the second ad; and
clustering the at least one map content item of the other one or more map content item with the second ad when the at least one map content item of the other one or more map content item is associated with the second ad.

40. The machine-readable medium of claim 39, the operations further comprising:
providing the first ad and second ad and the at least one map content item of the one or more map content items and the at least one map content item of the other one or more map content items for display within the map, wherein the first ad and the least one map content item of the one or more map content items is displayed as a first entity and the second ad and the at least one of the other one or more map content items is displayed as a second entity.

41. The machine-readable medium of claim 39, the operations further comprising:
ranking the one or more map content items according to the distance from each of the one or more map content items to the first ad; and
ranking the other one or more map content items according to the distance from each of the other one or more map content items to the second ad.
